(19) United States
(12) Patent Application Publication
(10) Pub. No.: US 2018/0078021 A1
(43) Pub. Date: Mar. 22, 2018

(54) EQUESTRIAN WATER BOTTLE HOLDER

(71) Applicant: Donna BATE, Northfield Center, OH (US)

(72) Inventor: Donna BATE, Northfield Center, OH (US)

(21) Appl. No.: 15/707,758

(22) Filed: Sep. 18, 2017

Related U.S. Application Data
(60) Provisional application No. 62/395,662, filed on Sep. 16, 2016.

(51) Int. Cl. A45F 3/16; A45F 5/00

(52) U.S. Cl. CPC A45F 3/16; A45F 5/00; B67C 3/24; A63B 2225/682; A45F 2200/0583

(57) ABSTRACT

A water bottle holder for equestrian environments includes a cup configured to hold a water bottle, a pair of arms configured to be positioned in proximity to opposing sides of a jump post of an equestrian jumping standard, and a removable pin configured to be inserted through apertures in the pair of arms and a hole of the jump post that is at the desired height. The cup can include a drainage hole. The cup can be configured to hold other items. The water bottle holder can include a tether that connects the removable pin to the rest of the water bottle holder. The water bottle holder can include hooks in the pair of arms and a standoff to secure the water bottle holder to a horizontal structure. The water bottle holder can include knobs for attachment to a keyhole track that can be associated with the jumping standard.

### RELATED APPLICATIONS

This application claims the benefit of U.S. Provisional Application Ser. No. 62/395,662 filed Sep. 16, 2016 which is herein incorporated by reference in its entirety.

### TECHNICAL FIELD

This application relates generally to a water bottle holding apparatus configured for use in equestrian environments. The application relates more particularly to a water bottle holder configured be removably attached to structures commonly found in equestrian environments.

### BACKGROUND

Many equestrian facilities have jumping standards that horses can jump over for training or competition. Jumping standards typically include a pair of jump posts, each having a series of holes, and a pole that rests at a desired height across the pole holders on pegs, jump cup pins or the like that are placed in corresponding holes of the jump posts.

Equestrian facilities can be indoor or outdoor and can include dirt or grass fields. Jumping standards are placed strategically to allow riders to safely jump their horses over the poles. Working with horses can be strenuous for riders and trainers, who may desire to have water available for rehydration. Riders and trainers often desire to have water close at hand so as not to interrupt practices or competition. However, carrying bottles of water is inconvenient. Placing bottles of water on the ground is not sanitary, and could be stepped upon by a horse potentially causing injury. If a bottle of water is placed on a jump post, it could be knocked over when a horse crosses the jumping standard. Therefore, riders and trainers typically place bottles of water somewhere secure, such as a side table or bleachers, far away from the field or arena where they practice.

### SUMMARY

In accordance with an example embodiment of the subject application, an equestrian holding apparatus includes a cup for holding a water bottle and other items, for example keys, a wallet, or edible items, a first arm attached to the cup that includes an aperture or hole that can be positioned in proximity to a hole that extends through the first side of a jump post of an equestrian jumping standard to a second side, and a second arm attached to the cup and the first arm that includes an aperture that can be positioned in proximity to the hole on the second side of the jump post. The equestrian holding apparatus further includes a removable pin that secures the equestrian holding apparatus to the jump post by placing the removable pin through the aperture in the first arm, through the hole in the jump post, and through the aperture of the second arm. The equestrian holding apparatus can include a tether to keep the removable pin in close proximity to the first arm. The equestrian holding apparatus can include hooks on the arm that work in cooperation with a standoff to secure the equestrian holding apparatus to horizontal structures.

In accordance with an example embodiment of the subject application, a water bottle holder includes a cup portion for holding the water bottle and other items, a first arm portion configured to be positioned in proximity to a first side of a jump post, and a second arm portion configured to be positioned in proximity to a second side of the jump post. The first arm portion and second arm portion include apertures configured to be positioned in proximity to a hole in the jump post that extends from the first side to the second side of the jump post. The water bottle holder includes a pin, for securing the water bottle holder to the jump post. The pin is configured to be inserted through the aperture in the first arm portion, through the hole in the jump post, and through the aperture in the second arm. The water bottle holder can include a tether for maintaining the pin in proximity to the first arm portion, for example by tying the tether to holes in the pin and first arm portion. The tether can be a string, plastic cord, a wire, a chain, a rubber band, or any other suitable material. The water bottle holder can include a standoff that pushes the cup portion away from a structure to which the water bottle holder is mounted so as to keep the water bottle holder from rotating into an undesirable orientation. The standoff can work with first and second hooks in the first and second arm to secure the water bottle holder to a substantially horizontal structure such as a piece of fencing or a board. The cup and arms can be constructed as a single unit from a material such as metal, plastic, or polyethylene. The water bottle holder can include knobs for attachment to a keyhole track.

In accordance with an example embodiment of the subject application, an equestrian water bottle holder includes a cup for holding a water bottle, a first arm attached to the cup that includes an aperture, and that is configured to be positioned in proximity a first side of a jump post, a second arm also attached to the cup that is configured to be positioned in proximity to a second side of the jump post, and a removable pin configured to be inserted through the first aperture, through a hold that extends through the jump post from the first side to the second side, and through the second aperture in order to secure the equestrian water bottle holder to the jump post.

### BRIEF DESCRIPTION OF THE DRAWINGS

Various embodiments will become better understood with regard to the following description, appended claims and accompanying drawings wherein:

FIG. 1 is a diagram of an example embodiment of an jumping standard;

FIG. 2 is a diagram of an example embodiment of an equestrian water bottle holder secured in holes of a jump post;

FIG. 3 is a diagram of an example embodiment of an equestrian water bottle holder secured to a keyhole track on a jump post;

FIG. 4 is a diagram of an example embodiment of an equestrian water bottle holders secured to a section of fencing;

FIG. 5 is a cutaway view of an example embodiment of an equestrian water bottle holder and a jump post having a keyhole track;

FIG. 6A is a top view of an example embodiment of an equestrian water bottle holder;

FIG. 6B is a side view of an example embodiment of an equestrian water bottle holder;

FIG. 6C is a front view of an example embodiment of an equestrian water bottle holder; and

FIG. 6D is a rear view of an example embodiment of an equestrian water bottle holder.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

An equestrian water bottle holder allows riders and trainers to have a water bottle for rehydration close at hand. Carrying bottles of water is inconvenient. Placing bottles of water on the ground is not sanitary, and could be stepped upon by a horse potentially causing injury. If a bottle of water is placed on a jump post, it could be knocked over when a horse crosses the jumping standard. Therefore, riders and trainers typically place bottles of water somewhere secure, such as a side table or bleachers, far away from the field or arena where they practice.

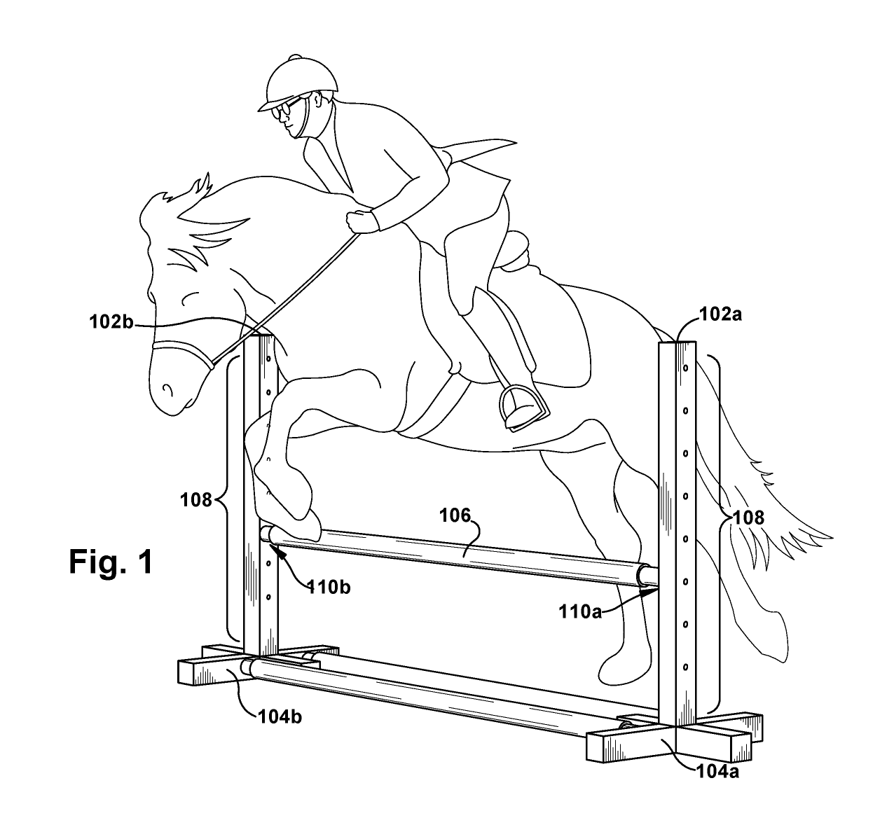

Referring to FIG. 1, an exemplary jumping standard 100 is presented. The jumping standard 100 includes a first jump post 102a and a second jump post 102b (collectively jump posts 102), and a pole 106 positioned between the jump posts. The jump posts 102 can be secured by bases 104, such as first base 104a and second base 104b (collectively bases 104). In a configuration, the jump posts 102 can be secured to the ground by other means, such as using longer jump posts 102 that are positioned in post holes in the ground. Jump posts 102 are typically constructed from wood, for example using 4-by-4 wood posts, but can be constructed from any suitable material including but not limited to plastic, PVC, or metal. Each of the jump posts 102 include a series of holes 108, the bottommost hole 108 being at approximately a foot from the ground and additional holes 108 positioned approximately every 4 inches along the jump posts 102. The holes 108 allow the pole 106 to be positioned at a desired height between the jump posts 102. The pole 106 can be loosely secured between the jump posts 102, for example using jump cup pins 110a and 110b (collectively jump cup pins). Jump cup pins 110 hold the pole 106 in position but also allow the pole 106 to break away and fall in the event a horse impacts the pole 106 during a jump. Other means for secured the pole 106 to the jump posts 106 can be used, including but not limited to U-shaped hangers, pegs, and so forth as would be understood in the art. In an embodiment, a jumping standard 100 can use keyhole tracks (not shown) that are mounted on the inside portions of the jump posts 102. In this embodiment, the jump cup pins 110 can be configured for attachment to the keyhole tracks.

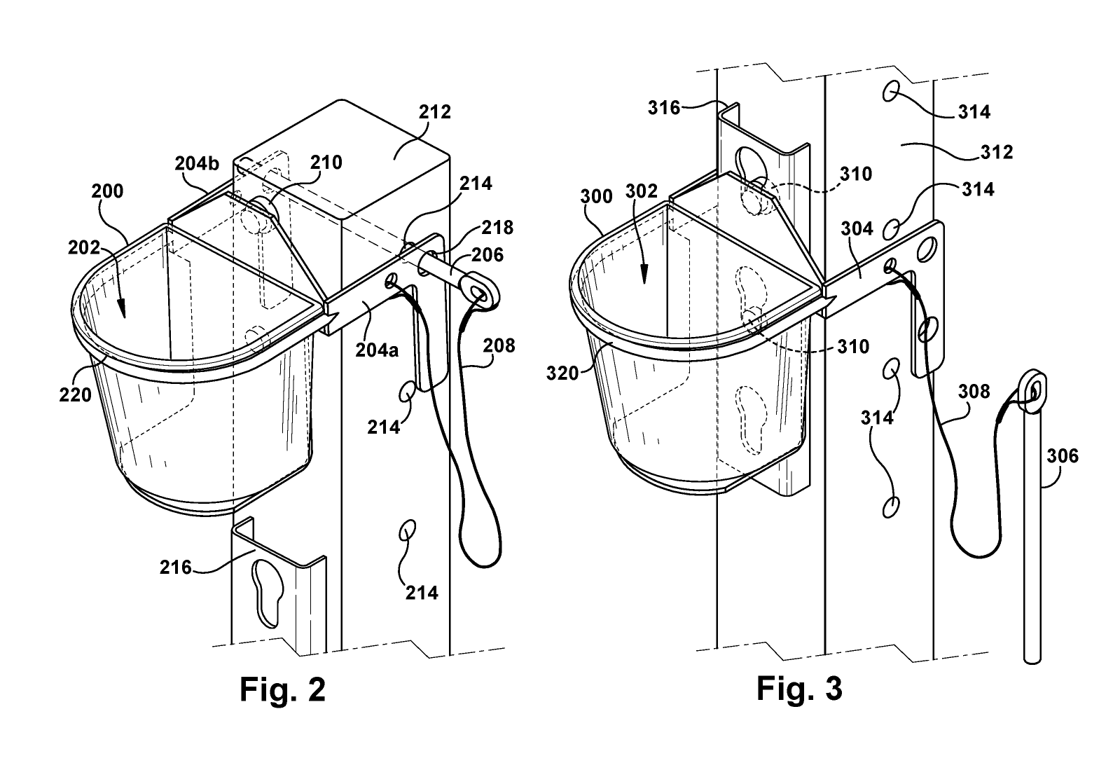

Referring now also to FIG. 2, an embodiment of an equestrian water bottle holder 200 is presented. The equestrian water bottle holder 200 includes a cup 202, arms 204a, 204b (collectively arms 204), and removable pin 206. In a configuration, the cup 202, also called a holder well, is constructed of plastic that is secured in place via a metal retaining loop 220, although other suitable means of retention and other suitable materials, including without limitation metal, polyethylene, and polystyrene, are contemplated. In an embodiment, the equestrian water bottle holder 200 can include a tether 208 that retain the removable pin 206 with the rest of the equestrian water bottle holder 200. In a configuration, the tether 208 is a string tied between the removable pin 206 and one of the arms 204. In various configurations, the tether 208 can be made of any suitable material including but not limited to a string, a plastic cord, a wire, a chain, and a rubber band. The equestrian water bottle holder 200 can be secured to a jump post 212 by positioning the arms 204 on either side of the jump post 212 in proximity to one of the holes 214 as illustrated and sliding the removable pin 206 through the arms 204 and the jump post 212. The removable pin 206 passes through an aperture 218, or hole, in the first arm 204a, into one of the holes 214 in the jump post 212, and through an aperture in the second arm 204b. The trainer or rider can select the appropriate hole 214 so that the equestrian water bottle holder 200 is at the desired height. For example, a trainer may desire to have the equestrian water bottle holder 200 at chest height, while a rider may desire to have the equestrian water bottle holder 200 at or near the top of the jump post 212 so that a water bottle placed in the equestrian water bottle holder 200 is reachable by the rider without dismounting from the horse. Advantageously, the equestrian water bottle holder 200 can be secured to any of the holes 218 in the jump post 212 to adjust to the needs of the individual using the equestrian water bottle holder 200. In an embodiment, the equestrian water bottle holder 200 can include one or more knobs 210 for securing the equestrian water bottle holder 200 to a keyhole track 216 as shown in FIG. 3 and as described below.

Referring now also to FIG. 3, an embodiment of the equestrian water bottle holder 300 includes a cup 302, a metal retaining loop 320 configured to secure the cup 302, and one or more knobs 310 (see also FIGS. 2, 5, and 6A-6D and accompanying description.) The equestrian water bottle holder 300 is secured to the jump post 312 by inserting the one or more knobs into a keyhole track 316 as would be understood in the art. In an embodiment, the equestrian water bottle holder 300 includes arms 304, however in this configuration the arms 304 and the removable pin 306 (with tether 308) are not used to secure the equestrian water bottle holder 300 to holes 314 in the jump post 312.

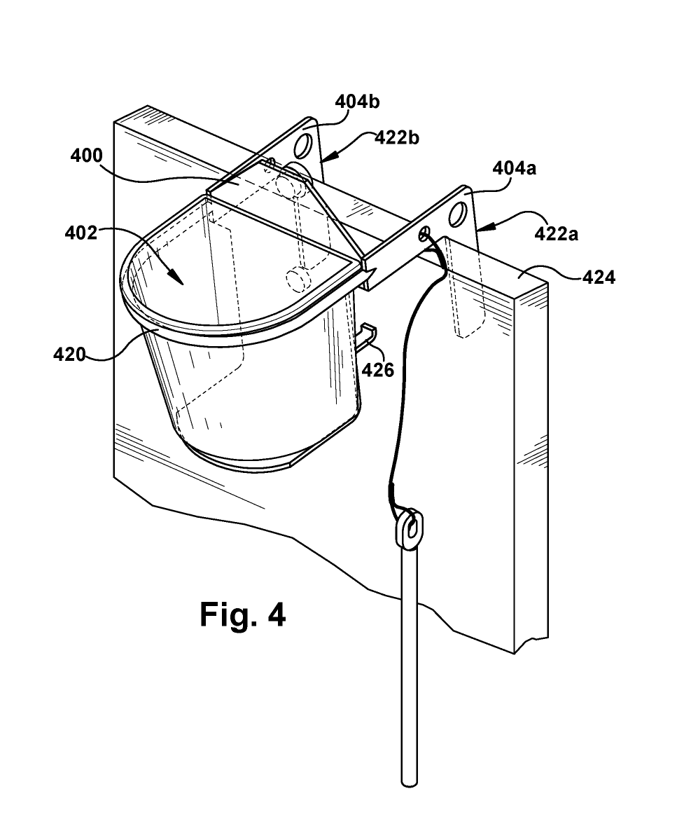

Referring now also to FIG. 4, a water bottle holder 400 can include a cup 402, metal retaining loop 420, and arms 404a, 404b (collectively arms 404). Each of the arms 404 can include a hook portion 422a, 422b (collectively hook portions 422) configured to hang the water bottle holder 400 off of a suitable horizontal structure, such as the top of a door 424 as illustrated. The length of the hook portions 422 can be configured to secure the water bottle holder 400 to horizontal structures of various widths as would be understood in the art. In a configuration, the water bottle holder 400 can include a fixed or adjustable standoff 426 that prevents the water bottle holder 400 from rotating when placed on the horizontal structure. An example fixed standoff 426 can be suitable piece of plastic or other material that folds out from the back of the water bottle holder 400. The fixed standoff 426 can be folded back against the water bottle holder 400 when not in use. An example adjustable standoff 426 can be a short piece of tubing or plastic that inserts into a suitable thru-hole (not shown) in or below the cup 402 and held in place by friction. When not in use, the adjustable standoff 426 can be withdrawn further into the thru-hole or placed in the cup 402. The water bottle holder 400 can be used in equestrian environments and secured to fences, stall walls, arena walls, barn walls, or the inside of a horse trailer. The water bottle holder 400 can be used in non-equestrian environments include non-limited examples such as a garage, a house, indoors for example in a craft room, outdoors for example on a deck rail, at work, at a gym, or in sports facility

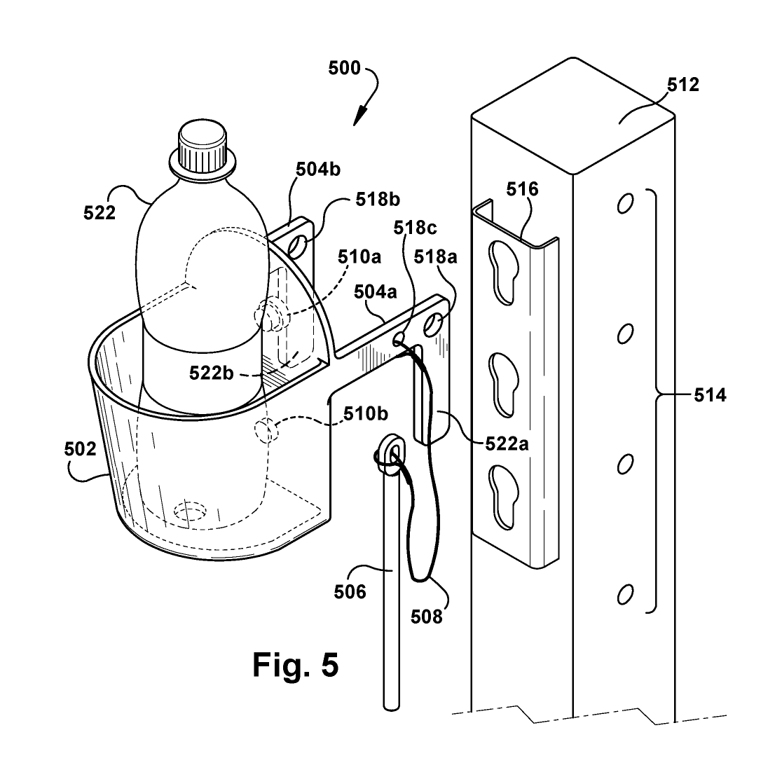

Referring to FIG. 5, an embodiment of an equestrian water bottle holder 500 can include a cup portion 502, arm portions 504a, 504b (collectively arm portions 504), hook portions 522a, 522b (collectively hook portions 522), tether 508, pin 506, and knobs 510a, 510b (collectively knobs 510). The knobs 510 are configured to secure the equestrian water bottle holder 500 to a keyhole track 516 on a jump post 516 as described above for FIG. 3. The hook portions 522 are configured to secure the equestrian water bottle holder 500 to any suitable horizontal structure as described above for FIG. 4. The arm portions 504 can include apertures 518a, 518b (collectively apertures 518). The pin 506 can be inserted through the apertures and through one of the holes 514 in the jump post 512 to secure the equestrian water bottle holder 500 to the jump post 512 as described above for FIG. 2. One end of the tether 508 can be tied, or otherwise connected, to the pin 506 and the other end can be tied, or otherwise connected, to another aperture 518c in the arm portion 504a. The equestrian water bottle holder 500 can be configured to hold a water bottle 522 as illustrated. In a configuration, the cup portion 502, arm portions 504, hook portions 522, and knobs 510 can be constructed as a single unit, for example out of a suitable plastic using injection molding as would be understood in the art. In embodiments, optional hook portions 522 or knobs 510 can be omitted. In an embodiment, the knobs 510 can be separately added to the other portions during manufacture and can be comprised of a different material. For example, the knobs 510 can be metal knobs attached to the cup portion 502 via threaded screws.

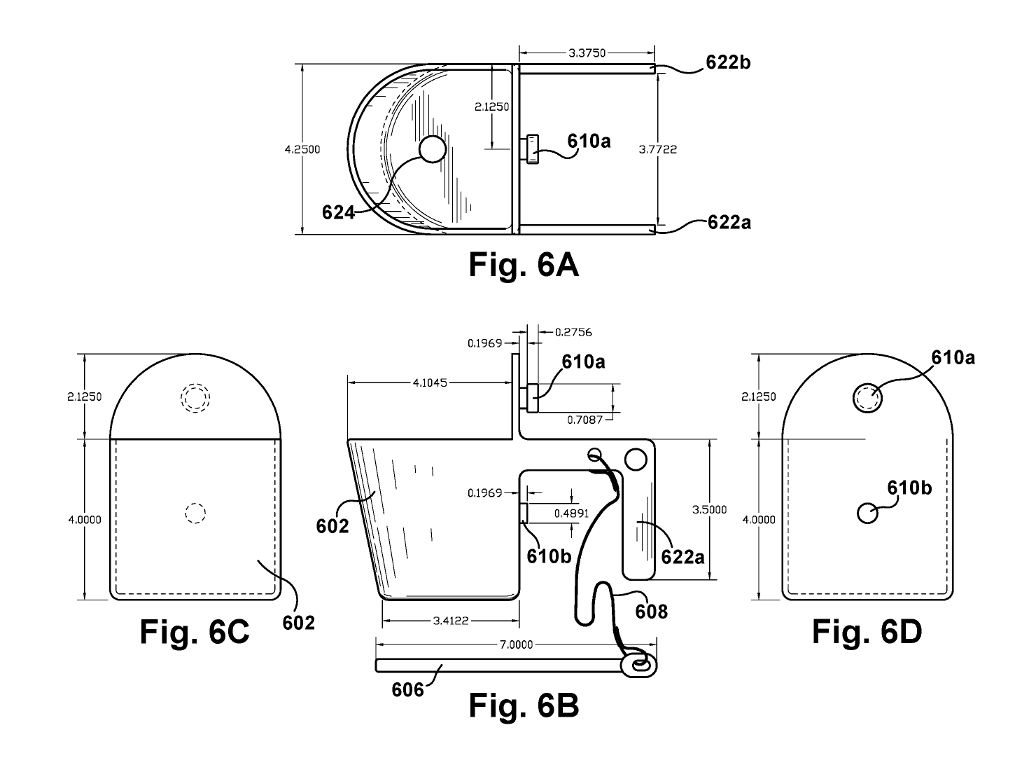

Referring now also to FIGS. 6A, 6B, 6C, and 6D, various exemplary features and measurements of an embodiment of an equestrian water bottle holder 600 are presented. The cup portion 602 of the equestrian water bottle holder 600 can include a drainage hole 624 to allow for water and condensation to drain. The cup portion 602 can be configured to accommodate standard water bottles or drink bottles up to approximately 26 oz. The cup portion 602 can be configured to hold additional items such as keys, wallets, cell phones, horse supplies, and any other suitable item or items.

The size of the equestrian water bottle holder 600 is approximately 6.5 inches high, 7.25 inches long, and 4.25 inches wide. The cup portion 602 is approximately 4.5 inches high, 4 inches long, and 3.75 inches wide at the top that tapes to approximately 3.5 inches long at the bottom. The drainage hole 624 can be approximately 0.375 inches in diameter. The arms are approximately 3.375 inches long, and 1 inch wide, with downward hooks that are approximately 2.5 inch long. Each arm has an approximately 0.5 inch diameter hole at the end for the pin to pass through and one arm as an approximately 0.1875 diameter hole for attaching the tether. The arms can be positioned approximately 4 inches apart to accommodate a standard size jump post. The pin can be made of metal and can measure approximately 7 inches long and 0.75 inches in diameter. One end of the pin can be flat and be 0.5 inches long by 0.75 inches wide with a 0.1875 inch diameter hold in the flat end for attaching the tether. The knobs can be configured to slide into a standard keyhole track. The top knob can be approximately 1.1 cm long, and include two portions, a cylindrical stem having an approximately 5 mm length with a 1.3 cm diameter, and a larger cylindrical portion measuring approximately 7 mm long with a 1.8 cm diameter. The bottom knob can be approximately 3 mm long with a 1.2 cm diameter.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. An equestrian holding apparatus, comprising:
a cup configured to hold at least a water bottle;
a first arm, in communication with the cup, having an aperture configured to be positioned in proximity to a hole on a first side of a jump post of an equestrian jumping standard that extends through the jump post to a second side of the jump post;
a second arm, in communication with the cup and the first arm, having a aperture configured to be positioned in proximity to the hole on the second side of the jump post; and
a removable pin configured to be displaced through the aperture of the first arm, through the hole in the jump post, and through the aperture of the second arm to secure the equestrian holding apparatus to the jump post.

2. The equestrian holding apparatus of claim 1, further comprising:
a tether configured to maintain the removable pin in proximity to the first arm.

3. The equestrian holding apparatus of claim 2,
wherein the first arm includes a second aperture,
wherein the removable pin includes an aperture, and
wherein a first end of the tether is connected to the first arm using the second aperture, and
wherein a second end of the tether is connected to the removable pin using the aperture in the removable pin.

4. The equestrian holding apparatus of claim 2, wherein the tether is selected from the group consisting of a string, a plastic cord, a wire, a chain, and a rubber band.

5. The equestrian holding apparatus of claim 1, wherein the first arm includes a first hook, wherein the second arm includes a second hook, and further comprising:
a standoff configured to secure the equestrian holding apparatus to a substantially horizontal structure in cooperation with the first hook and the second hook.

6. The equestrian holding apparatus of claim 1, further comprising:
a knob configured to secure the equestrian holding apparatus to a keyhole track.

7. The equestrian holding apparatus of claim 6, further comprising:
a second knob configured to secure the equestrian holding apparatus to a keyhole track in cooperation with the first knob.

8. The equestrian holding apparatus of claim 7, wherein the second knob is a cylinder approximately 3 mm in length and approximately 1.2 cm in diameter.

9. The equestrian holding apparatus of claim 6, wherein the knob includes a first portion comprising a substantially cylindrical stem approximately 5 mm in length and approximately 1.3 cm in diameter, and a second substantially cylindrical portion approximately 7 mm long and approximately 1.8 cm in diameter.

10. The equestrian holding apparatus of claim 1, further comprising:
a metal retaining loop configured to secure the cup to the first arm and the second arm.

11. The equestrian holding apparatus of claim 1, wherein the cup is selected from the group consisting of a metal cup, a plastic cup, a polyethylene cup, and a polystyrene cup.

12. The equestrian holding apparatus of claim 11, wherein the cup includes a drainage aperture.

13. A water bottle holder, comprising:
a cup portion configured to hold at least a water bottle;
a first arm portion configured to be positioned in proximity to a first side of a jump post of an equestrian jumping standard, the first arm portion including an aperture configured to be positioned in proximity to a hole on the first side of the jump post that extends through the jump post to second side of the jump post;
a second arm portion configured to be positioned in proximity to the second side of the jump post, the second arm portion including an aperture configured to be positioned in proximity to the hole on the second side of the jump post; and
a pin configured to be inserted through the aperture of the first arm portion, through the hole in the jump post, and through the aperture of the second arm to secure the water bottle holder to the jump post.

14. The water bottle holder of claim 13, further comprising:
a tether configured to maintain the pin in proximity to the first arm portion,
wherein the tether is selected from the group consisting of a string, a plastic cord, a wire, a chain, and a rubber band.

15. The water bottle holder of claim 14,
wherein the first arm portion includes a second aperture,
wherein the pin includes an aperture, and
wherein a first end of the tether is connected to the first arm portion using the second aperture, and
wherein a second end of the tether is connected to the pin using the aperture in the removable pin.

16. The water bottle holder of claim 13, further comprising:
a standoff configured to push the cup portion away from a structure to which the water bottle holder is secured.

17. The water bottle holder of claim 13, wherein the first arm portion includes a first hook, wherein the second arm portion includes a second hook, and wherein the standoff, first hook, and second hook are configured to secure the water bottle holder to a substantially horizontal structure different from the jump post.

18. The water bottle holder of claim 13, further comprising:
a first knob that includes a first cylinder of a first diameter and a second cylinder having a second diameter greater than the first diameter; and
a second knob that includes a third cylinder of a third diameter,
wherein the first knob and the second knob are configured to secure the water bottle holder to a keyhole track associated with the equestrian jumping standard.

19. The water bottle holder of claim 13, wherein the cup portion, first arm portion, and second arm portion are constructed as a single unit from a material is selected from the group consisting metal, plastic, and polyethylene.

20. An equestrian water bottle holder, comprising:
a cup configured to hold a water bottle;
a first arm, attached to the cup, having a first aperture and configured to be positioned in proximity to a first side of a jump post of an equestrian jumping standard;
a second arm, attached to the cup, having a second aperture and configured to be positioned in proximity to a second side of the jump post;
a removable pin configured to be inserted through the first aperture, through a hole in the jump post that extends from the first side to the second side, and through the second aperture of the second arm to secure the equestrian water bottle holder to the jump post; and
a tether secured to the equestrian water bottle holder via a length of flexible material and configured to retain the removable pin in proximity to the equestrian water bottle holder when the removable pin is not inserted through the first aperture, the hole, and the second aperture.
